(19) United States
(12) Patent Application Publication
(10) Pub. No.: US 2008/0160923 A1
(43) Pub. Date: Jul. 3, 2008

(54) Signal transmission system for driving a power semiconductor switch, and a converter having such a signal transmission system

(75) Inventors: Nikola Celanovic, Baden (CH); Luc Meysenc, Le Fontanil (FR); Michael Mazur, Zurich (CH); Paul Rudolf, Villigen (CH)

Correspondence Address: BUCHANAN, INGERSOLL & ROONEY PC, POST OFFICE BOX 1404, ALEXANDRIA, VA, 22313-1404, US

(73) Assignee: ABB Research Ltd, Zurich (CH)

(21) Appl. No.: 11/783,448

(22) Filed: Apr. 10, 2007

Related U.S. Application Data
(63) Continuation of application No. PCT/CH05/00574, filed on Oct. 4, 2005.

(30) Foreign Application Priority Data
Oct. 15, 2004 (EP) 04405648.9

(51) Int. Cl. H04B 7/00; H04B 1/00

(52) U.S. Cl. 455/70

(57) ABSTRACT

A signal transmission system is used to drive at least one power semiconductor switch (S₁, S₂, . . . , Sₙ) from a controller (11). The controller (11) can transmit at least one control signal to at least one modulator (M₁, M₂, . . . , Mₙ) using at least one first transmission path (3). Each power semiconductor switch (S₁, S₂, . . . , Sₙ) is connected to a respective control electrode driver stage (G₁, G₂, . . . , Gₙ) and the at least one modulator (M₁, M₂, . . . , Mₙ) can transmit at least one drive signal to each of the control electrode driver stages (G₁, G₂, . . . , Gₙ) using a respective second transmission path (4). At least one control signal and/or a drive signal can be transmitted using electromagnetic radiation and the associated transmission path (3, 4) is wireless.

### TECHNICAL FIELD

The invention relates to the field of power electronics. It relates to a signal transmission system for driving at least one power semiconductor switch and to a converter according to the precharacterizing clauses of the independent claims.

### PRIOR ART

FIG. 1 shows a conventional signal transmission system for a converter. According to FIG. 1, a drive device 1 comprises a controller 11 and a modulator M₁. A first transmission path 3 is situated between the controller 11 and the modulator M₁ and comprises a cable as well as light-wave transmitters, such as diodes, for transmitting signals and light-wave receivers, such as diodes, for receiving signals. A power-electronics circuit 2 comprises control electrode driver stages G₁, G₂, . . . , Gₙ which are each connected to a power semiconductor switch S₁, S₂, . . . , Sₙ. A respective second transmission path 4 which respectively comprises an optical waveguide, such as a glass fiber cable or a fiber optic cable comprising plastic, as well as diodes for transmitting and receiving signals is situated between the modulator M₁ and each control electrode driver stage G₁, G₂, . . . , Gₙ. In this case, the second transmission paths 4 are arranged in a star structure.

Monitoring sensors F₁, F₂, . . . , Fₙ may also be provided in the power-electronics circuit 2 for the purpose of measuring the states of individual components in the power-electronics circuit 2 or of the entire power-electronics circuit 2. A respective third transmission path 8 which respectively comprises an optical waveguide as well as diodes for transmitting and receiving signals is situated between the monitoring sensors F₁, F₂, . . . , Fₙ and the controller 11.

A reference value 7 is transmitted to the controller 11. A control signal is determined from the reference value 7 in the controller 11. The control signal is transmitted from the controller 11 to the modulator M₁ using the first transmission path 3. The duty factor for each individual switch S₁, S₂, . . . , Sₙ is determined from the control signal in the modulator M₁. The duty factor corresponds to the interval of time between two switching operations of a switch S1, S₂, . . . , Sₙ, each switch S₁, S₂, . . . , Sₙ being able to change only between two switching states—switched on and switched off. A respective drive signal containing the command to switch the associated switch S₁, S₂, . . . , Sₙ on or off is transmitted by the modulator M₁ to each individual control electrode driver stage G₁, G₂, . . . , Gₙ using a diode and a respective second transmission path 4 and is received in said control electrode driver stage using diodes. The states of individual components in the power-electronics circuit or of the entire power-electronics circuit are measured in the monitoring sensors F₁, F₂, . . . , Fₙ. The measured values are transmitted to the modulator M₁, in the form of feedback signals, using diodes and are received in said modulator using diodes and are taken into account when determining the duty factor of the switches S₁, S₂, . . . , Sₙ. In the case of such a star structure of the second transmission paths 4, an interface is required for each converter, said interface being designed for precisely the number of switches in the converter. If the converter is intended to be changed to a different number of switches, it is necessary to create a new interface.

Another way of arranging the switches is a ring structure in which, starting with the modulator, each switch is connected to the next switch in sequence using an optical waveguide. Such an arrangement can be constructed in a simple and cost-effective manner but is highly susceptible to faults because the failure of one individual switch or damage in one of the optical waveguides or the connections of the optical waveguides results in failure of the entire ring structure. Another problem is the time delay with which the signal propagates over the ring structure and which causes each switch to be switched with a time delay in comparison with the previously switched switch.

The problem with the abovementioned transmission paths, in particular with optical waveguides, is that they are unreliable. A signal is no longer transmitted if a diode fails. In addition, a very effective junction between the optical waveguides and diodes is required in order to be able to transmit the signals reliably, and this junction is susceptible to faults. In addition, optical waveguides and cables are mechanically sensitive and sensitive to contamination. Therefore, such cabling is unreliable, particularly in a harsh environment. The cabling is complicated during manufacture and in the case of a repair and additionally requires a large amount of space.

U.S. Pat. No. 5,210,479 describes a drive unit for an IGBT, which detects the state of the IGBT and transmits signals for controlling the IGBT using a conductor. In the case of an overcurrent signal in the IGBT, a feedback signal is generated, said feedback signal being transmitted from a light-emitting diode connected to the IGBT to a phototransistor in the drive unit and being used as a basis for controlling the IGBT to a prescribed value within the SOA (“safe operating area”) again.

U.S. Pat. No. 5,383,082 describes a system for protecting a power semiconductor switch, such as an IGBT, a power MOSFET or a bipolar transistor, from an overcurrent. A first LED which is connected to a control unit transmits a drive signal to a first phototransistor which is, in turn, connected to the IGBT. A second LED is arranged between the gate of the IGBT and a voltage supply for the gate voltage. In the event of an overcurrent, the second LED transmits a signal to a second phototransistor which is connected to the drive unit. The second LED is used, on the one hand, to limit the gate voltage and, on the other hand, to transmit an overcurrent signal to the drive unit, which overcurrent signal can be used to control the IGBT. With this arrangement, the drive unit is DC-isolated from the IGBT.

### DESCRIPTION OF THE INVENTION

Therefore, it is an object of the invention to provide a signal transmission system for driving at least one power semiconductor switch with improved reliability. Furthermore, it is the object of the invention to specify a converter with improved reliability.

According to the invention, these objects are achieved by means of the features of independent patent claims 1, 6 and 7.

The inventive signal transmission system is used to drive at least one power semiconductor switch of a power-electronics circuit from a controller, each power semiconductor switch being connected to a respective control electrode driver stage. At least one control signal can be transmitted from the controller to at least one modulator using at least one first transmission path. The at least one modulator can transmit at least one drive signal to each of the control electrode driver stages using a respective second transmission path. According to the invention, at least one control signal and/or one drive signal can be transmitted using electromagnetic radiation and the at least one associated first or second transmission path is wireless. As a result of the wireless transmission of the at least one control signal and/or of the at least one drive signal, the signal transmission system has improved reliability and additionally becomes mechanically stable and insensitive to dust. When producing a power-electronics apparatus comprising a controller, at least one first transmission path, at least one modulator, at least one second transmission path and at least one power semiconductor switch with a respective control electrode driver stage, the costs for laying the optical waveguides and/or cables for the at least one first and/or second transmission path, which is wireless, are additionally dispensed with.

If at least one control signal can be transmitted using electromagnetic radiation and the associated at least one first transmission path is wireless, the at least one control signal to be transmitted comprises a small quantity of data, with the result that a high transmission rate is not required. Signal transmission using electromagnetic radiation is advantageous because data can be transmitted in a reliable manner.

If at least one drive signal can be transmitted using electromagnetic radiation and the associated at least one second transmission path is wireless, signal transmission using electromagnetic radiation is advantageous because large quantities of data can be transmitted in a reliable manner.

In another embodiment of the invention, at least one power semiconductor switch is connected to a respective monitoring sensor for measuring a respective state value. At least one third transmission path for transmitting a respective feedback signal from at least one of the at least one monitoring sensor leads to at least one modulator or to the controller. At least one feedback signal can be transmitted using electromagnetic radiation and the associated at least one third transmission path is wireless. The advantage of this embodiment is that there is no need for any cabling between the at least one monitoring sensor and the at least one modulator or the controller.

One of the abovementioned signal transmission systems can be advantageously used in a converter because a converter comprises a plurality of power semiconductor switches which can be switched in a reliable manner using the inventive signal transmission system and thus have a high level of availability. Such inventive converters are additionally mechanically stable and are insensitive to contamination to the greatest possible extent.

These and other objects, advantages and features of the present invention become apparent from the following detailed description of preferred exemplary embodiments of the invention in conjunction with the drawings.

### BRIEF DESCRIPTION OF THE DRAWINGS

In the drawings:

FIG. 1 shows a conventional signal transmission system with a star structure;

FIG. 2 shows an inventive signal transmission system having a wireless first transmission path between a controller and a modulator;

FIG. 3 shows an inventive signal transmission system having n wireless first transmission paths between the controller and n modulators;

FIG. 4 shows an inventive signal transmission system having n wireless second transmission paths between the modulator and n control electrode driver stages;

FIG. 5 shows an inventive signal transmission system having n wireless second transmission paths between the modulator and n control electrode driver stages, a modulated drive signal packet being able to be transmitted from a transmitter; and

FIG. 6 shows an inventive signal transmission system having n wireless third transmission paths between n monitoring sensors and the controller.

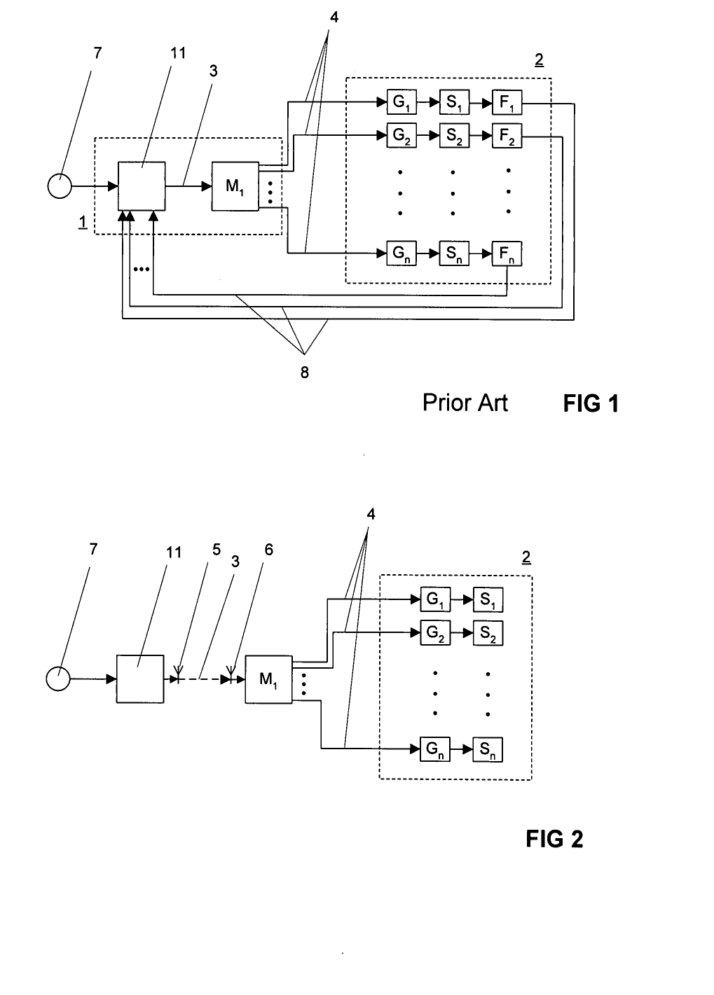

The reference symbols used in the drawings are summarized in the list of reference symbols. In principle, identical parts are provided with identical reference symbols in the drawings. The embodiments described represent examples of the subject matter of the invention and are not restrictive.

### WAYS OF IMPLEMENTING THE INVENTION

In the following embodiments, an optical waveguide is to be understood as meaning an optical waveguide which comprises a conductor for transmitting signals as well as a light-wave transmitter for transmitting signals and a light-wave receiver for receiving signals.

FIG. 2 shows a first embodiment of the inventive subject matter. A first transmission path 3 is arranged between a controller 11 and a modulator M₁. The controller 11 is connected to a transmitter 5 for transmitting electromagnetic radiation and the modulator M₁ is connected to a receiver 6 for receiving electromagnetic radiation. The first transmission path 3 is wireless. This is illustrated in FIG. 2 by means of a dashed line between the controller 11 and the modulator M₁. A power-electronics circuit 2 comprises at least one control electrode driver stage G₁, G₂, . . . , Gₙ and at least one power semiconductor switch S₁, S₂, . . . , Sₙ. Optical waveguides, such as glass fiber cables or fiber optic cables comprising plastic, pass from the modulator M₁ to each of the control electrode driver stages G₁, G₂, . . . , Gₙ on a respective second transmission path 4. Each of the control electrode driver stages G₁, G₂, . . . , Gₙ is connected to a respective power semiconductor switch S₁, S₂, . . . , Sₙ.

In FIG. 2, a reference value 7 is transmitted to the controller 11. A control signal is determined from the reference value 7 in the controller 11. The control signal is transmitted from the transmitter 5 to the receiver 6 using electromagnetic radiation and the first transmission path 3. In the modulator M₁, the control signal is used to determine when the individual switches S₁, S₂, . . . , Sₙ are intended to be switched. The modulator M₁ uses a respective second transmission path 4 to transmit a respective drive signal to a respective control electrode driver stage G₁, G₂, . . . , Gₙ, said drive signal containing the command to switch the switch S₁, S₂, . . . , Sₙ, which is connected to each control electrode driver stage G₁, G₂, . . . , Gₙ, on or off. The control electrode driver stages G₁, G₂, . . . , Gₙ then initiate the changeover operation in the associated switches S₁, S₂, . . . , Sₙ.

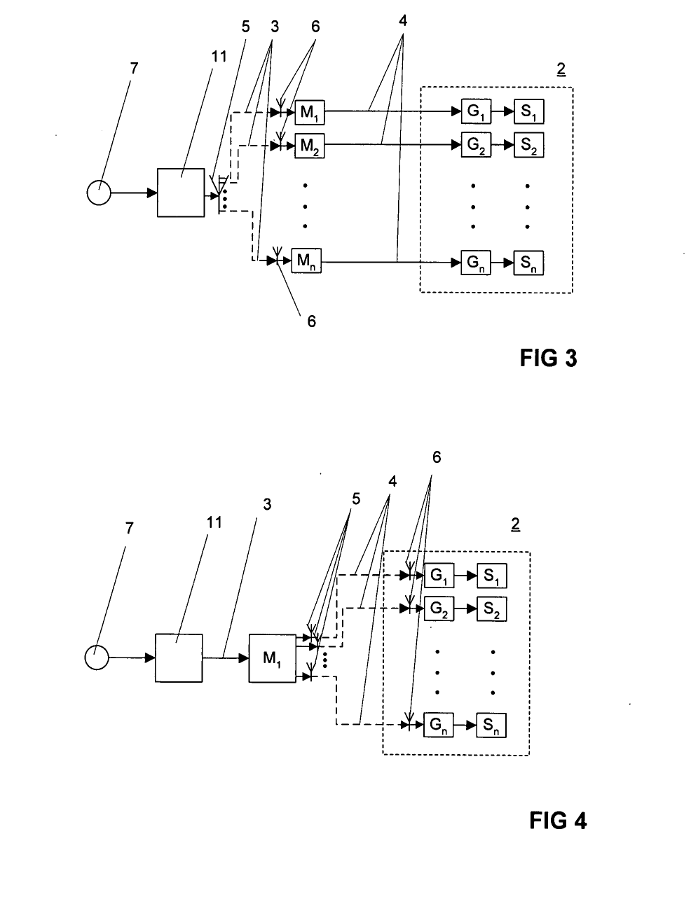

In a variant which is illustrated in FIG. 3, a plurality of first transmission paths 3 are formed between the controller 11 and a plurality of modulators M₁, M₂, . . . , Mₙ. The controller 11 is connected to a transmitter 5. The at least one modulator M₁, M₂, . . . , Mₙ is connected to a respective receiver 6. A respective second transmission path 4 leads from the modulators M₁, M₂, . . . , Mₙ to a respective control electrode driver stage G₁, G₂, . . . , Gₙ. Each of the control electrode driver stages G₁, G₂, . . . , Gₙ is connected to a respective power semiconductor switch S₁, S₂, . . . , Sₙ.

In FIG. 3, a reference value 7 is transmitted to the controller 11. A control signal is determined from the reference value 7 in the controller 11. The control signal is transmitted from the controller 11 to the plurality of modulators M₁, M₂, . . . , Mₙ using electromagnetic radiation and the plurality of first transmission paths 3. Each modulator M₁, M₂, . . . , Mₙ determines, for an associated switch S₁, S₂, . . . , Sₙ, when this switch S₁, S₂, . . . , Sₙ is intended to be switched and transmits a respective drive signal to the associated control electrode driver stage G₁, G₂, . . . , Gₙ using a respective second transmission path 4. The control electrode driver stages G₁, G₂, . . . , Gₙ then initiate the changeover operation in the associated switches S₁, S₂, . . . , Sₙ.

The embodiments illustrated in FIG. 2 and FIG. 3 can be advantageously used in a signal transmission system in which a drive device 1 comprises a controller 11 and the power-electronics circuit 2 comprises the at least one modulator M₁, M₂, . . . , Mₙ and the at least one control electrode driver stage G₁, G₂, . . . , Gₙ with the respective associated switch S₁, S₂, . . . , Sₙ. In such an arrangement, the at least one wireless first transmission path 3 is arranged between the controller 11 in the drive device 1 and the at least one modulator M₁, M₂, . . . , Mₙ in the power-electronics circuit 2. As a result, there is no need for any optical waveguides between the drive device 1 and the power-electronics circuit 2 or at least that part of the power-electronics circuit 2 in which the at least one first transmission path 3 to the at least one modulator M₁, M₂, . . . , Mₙ is wireless, and the signal transmission system has improved reliability and additionally becomes mechanically stable and robust as regards contamination.

FIG. 4 shows another embodiment of the inventive subject matter. A first transmission path 3 is formed between a controller 11 and a modulator M₁. On the first transmission path 3, the controller 11 is connected to the modulator M₁ by means of a cable. A power-electronics circuit 2 comprises at least one control electrode driver stage G₁, G₂, . . . , Gₙ and at least one power semiconductor switch S₁, S₂, . . . , Sₙ. A respective second transmission path 4 leads from the modulator M₁ to the at least one control electrode driver stage G₁, G₂, . . . , Gₙ. The modulator M₁ is connected to at least one transmitter 5 and the at least one control electrode driver stage G₁, G₂, . . . , Gₙ is connected to a respective receiver 6. At least one second transmission path 4 is wireless. This is illustrated in FIG. 4 by means of dashed lines between the modulator M₁ and each of the control electrode driver stages G₁, G₂, . . . , Gₙ. Each of the control electrode driver stages G₁, G₂, . . . , Gₙ is connected to a respective power semiconductor switch S₁, S₂, . . . , Sₙ.

In FIG. 4, a reference value 7 is transmitted to the controller 11. A control signal is determined from the reference value 7 in the controller 11. A control signal is transmitted from the controller 11 to the modulator M₁ using the first transmission path 3, the duty factor for each individual switch being determined from the control signal in said modulator. A respective drive signal is transmitted from the transmitter 5 to a respective control electrode driver stage G₁, G₂, . . . , Gₙ using electromagnetic radiation and a respective second transmission path 4, said drive signal containing the command to switch the associated switch S₁, S₂, . . . , Sₙ on or off.

In one variant of the embodiment shown in FIG. 4, only the duty factor of each individual switch S₁, S₂, . . . , Sₙ is transmitted, as a drive signal, to the at least one control electrode driver stage G₁, G₂, . . . , Gₙ. Each control electrode driver stage G₁, G₂, . . . , Gₙ is connected to a logic unit in which the duty factor is used to determine the point in time at which the associated switch S₁, S₂, . . . , Sₙ is intended to be switched.

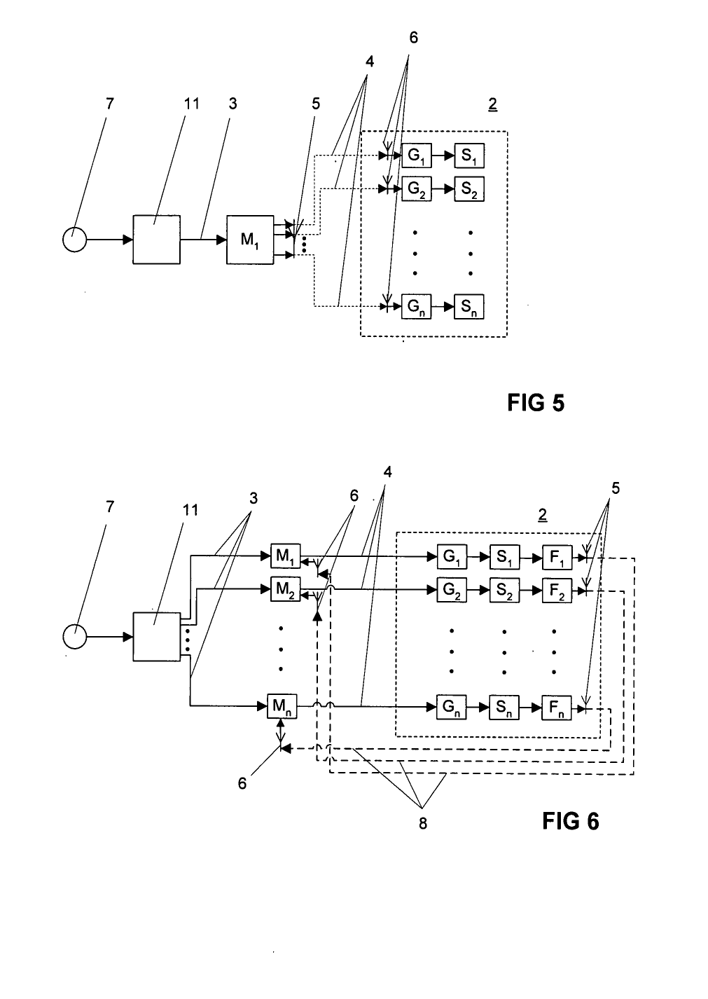

FIG. 5 shows another embodiment of the inventive subject matter. A first transmission path 3 is formed between a controller 11 and a modulator M₁. On the first transmission path 3, the controller 11 is connected to the modulator M₁ by means of a cable. A power-electronics circuit 2 comprises at least one control electrode driver stage G₁, G₂, . . . , Gₙ and at least one power semiconductor switch S₁, S₂, . . . , Sₙ. A respective second transmission path 4 leads from the modulator M₁ to the at least one control electrode driver stage G₁, G₂, . . . , Gₙ. The modulator M₁ is connected to a transmitter 5 and the at least one control electrode driver stage G₁, G₂, . . . , Gₙ is connected to a respective receiver 6. At least one second transmission path 4 is wireless. This is illustrated in FIG. 5 by means of dashed lines between the modulator M₁ and each of the control electrode driver stages G₁, G₂, . . . , Gₙ. Each of the control electrode driver stages G₁, G₂, . . . , Gₙ is connected to a respective power semiconductor switch S₁, S₂, . . . , Sₙ.

In FIG. 5, a reference value 7 is transmitted to the controller 11. A control signal is determined from the reference value 7 in the controller 11. A control signal is transmitted from the controller 11 to the modulator M₁ using the first transmission path 3, the duty factor for each individual switch being determined from the control signal in said modulator. In the modulator M₁, at least two of the drive signals are modulated using a conventional modulation method and are packaged into a modulated drive signal packet. The modulated drive signal packet is transmitted from the transmitter 5 to the associated control electrode driver stages G₁, G₂, . . . , Gₙ using electromagnetic radiation and a respective second transmission path 4, said drive signal packet containing the command to switch the associated switches S₁, S₂, . . . , Sₙ on or off. The modulated drive signal packet is demodulated in the associated control electrode driver stages G₁, G₂, . . . , Gₙ and the corresponding drive signals are assigned to the control electrode driver stages G₁, G₂, . . . , Gₙ. The control electrode driver stages G₁, G₂, . . . , Gₙ then initiate the changeover operation in the associated switches S₁, S₂, . . . Sₙ.

In one variant of the embodiment shown in FIG. 5, at least two of the duty factors of each individual switch S₁, S₂, . . . , Sₙ are modulated using a conventional modulation method in the modulator M₁ and are packaged into a modulated drive signal packet and are transmitted to the at least one control electrode driver stage G₁, G₂, . . . , Gₙ. The modulated drive signal packet is demodulated in the associated control electrode driver stages G₁, G₂, . . . , Gₙ and the corresponding duty factors are assigned to the control electrode driver stages G₁, G₂, . . . , Gₙ. The associated control electrode driver stages G₁, G₂, . . . , Gₙ are connected to a respective logic unit in which the duty factor is used to determine the point in time at which the associated switch S₁, S₂, . . . , Sₙ is intended to be switched. The control electrode driver stages G₁, G₂, . . . , Gₙ then initiate the changeover operation in the associated switches S₁, S₂, . . . , Sₙ.

In another embodiment which is not illustrated for the sake of clarity, at least one control signal can be transmitted using electromagnetic radiation and the at least one associated first transmission path 3 is wireless and at least one drive signal can be transmitted using electromagnetic radiation and the at least one associated second transmission path 4 is wireless.

FIG. 6 shows another embodiment of the inventive subject matter. At least one associated first transmission path 3 is formed between a controller 11 and at least one modulator M₁, M₂, . . . , Mₙ. On the at least one first transmission path 3, the controller 11 is connected to the at least one modulator M₁, M₂, . . . , Mₙ by means of optical waveguides. A power-electronics circuit 2 comprises at least one control electrode driver stage G₁, G₂, . . . , Gₙ, at least one power semiconductor switch S₁, S₂, . . . , Sₙ and at least one monitoring sensor F₁, F₂, . . . , Fₙ. Optical waveguides, such as glass fiber cables or fiber optic cables comprising plastic, pass from the at least one modulator M₁, M₂, . . . , Mₙ to each of the control electrode driver stages G₁, G₂, . . . , Gₙ on a respective second transmission path 4. Each of the control electrode driver stages G₁, G₂, . . . , Gₙ is connected to a respective power semiconductor switch S₁, S₂, . . . , Sₙ At least one power semiconductor switch S₁, S₂, . . . , Sₙ is connected to a respective monitoring sensor F₁, F₂, . . . , Fₙ. A respective third transmission path 8 is formed between at least one monitoring sensor F₁, F₂, . . . , Fₙ and the at least one modulator M₁, M₂, . . . , Mₙ. At least one monitoring sensor F₁, F₂, . . . , Fₙ is connected to a transmitter 5 for transmitting electromagnetic radiation and the at least one modulator M₁, M₂, . . . , Mₙ is connected to a receiver 6 for receiving electromagnetic radiation. The at least one associated third transmission path 8 is wireless. This is illustrated in FIG. 6 by means of a dashed line between the monitoring sensors F₁, F₂, . . . , Fₙ and the at least one modulator M₁, M₂, . . . , Mₙ.

In FIG. 6, a reference value 7 is transmitted to the controller 11. A control signal is determined from the reference value 7 in the controller 11. The at least one control signal is transmitted from the controller 11 to the at least one modulator M₁. M₂, . . . , Mₙ using the at least one first transmission path 3. In the at least one modulator M₁, M₂, . . . , Mₙ, the control signal is used to determine when the at least one switch S₁, S₂, . . . , Sₙ is intended to be switched. The at least one modulator M₁, M₂, . . . , Mₙ uses a respective second transmission path 4 to transmit a respective drive signal to a respective control electrode driver stage G₁, G₂, . . . , Gₙ, said drive signal containing the command to switch the switch S₁, S₂, . . . , Sₙ, which is connected to each control electrode driver stage G₁, G₂, . . . , Gₙ, on or off. The control electrode driver stages G₁, G₂, . . . , Gₙ then initiate the changeover operation in the associated switches S₁, S₂, . . . , Sₙ. The at least one monitoring sensor F₁, F₂, . . . , Fₙ is used to measure a state of an individual component in the power-electronics circuit 2 or of the entire power-electronics circuit 2, such as a voltage or a current. The state value is wirelessly transmitted, as a feedback signal, from the transmitter 5 to the receiver 6 and is taken into account when determining the duty factor of the switches S₁, S₂, . . . , Sₙ.

It is also possible for the state value to be an item of information such as a fault, for example failure of a switch S₁, S₂, . . . , Sₙ, or an error in one of the transmitted signals.

In a variant of the embodiment of the invention shown in FIG. 6, the at least one third transmission path 8 passes from the at least one monitoring sensor F₁, F₂, . . . , Fₙ to the controller 11.

In another variant of the embodiment shown in FIG. 6, the at least one monitoring sensor F₁, F₂, . . . , Fₙ can also be connected to other components in the power-electronics circuit 2 rather than to at least one power semiconductor switch S₁, S₂, . . . , Sₙ.

As a further variant of the embodiment shown in FIG. 6, it is also conceivable for at least one control electrode driver stage G₁, G₂, . . . , Gₙ to comprise a logic unit which the corresponding control electrode driver stage can use to react to faults. The at least one feedback signal can be directly transmitted to at least one control electrode driver stage G₁, G₂, . . . , Gₙ using electromagnetic radiation and in a wireless manner and can be taken into account in said control electrode driver stage when switching the associated switches S₁, S₂, . . . , Sₙ.

In another embodiment which is not illustrated for the sake of clarity, at least one feedback signal can be transmitted using electromagnetic radiation and the at least one associated third transmission path 8 is wireless. In addition, at least one control signal can be transmitted using electromagnetic radiation and the at least one associated first transmission path 8 is wireless and/or at least one drive signal can be transmitted using electromagnetic radiation and the at least one associated second transmission path 4 is wireless.

The at least one control signal and/or the at least one drive signal and/or the at least one feedback signal can be modulated using a modulation method for transmission using electromagnetic radiation. Conventional modulation methods, for example frequency modulation, time modulation or phase modulation, are suitable as the modulation method. Electromagnetic radiation in the range from 0.4 GHz to 400 GHz (gigahertz) is particularly suitable as at least one carrier frequency for such modulation. In converters, noise occurs at frequencies up to several hundred hertz, with the result that, when transmitting signals in the gigahertz range, said signals are not adversely affected by the noise in the converter. In addition, the transmission rate is high in this frequency range and signal transmission is cost-effective.

Antennas whose transmission range and/or reception range is/are designed for the frequency range in which the corresponding signal(s) is/are transmitted may be used as the at least one transmitter 5 and the at least one receiver 6.

The above-described embodiments of the inventive subject matter comprise only one controller 11. However, it is also conceivable for the signal transmission system to comprise a plurality of controllers 11 and for each of the controllers to transmit at least one control signal to at least one respective modulator M₁, M₂, . . . , Mₙ.

Each of the at least one first and/or second transmission paths 3, 4 can also be used to return feedback signals on the corresponding transmission path 3, 4 and thus to make it possible to provide rapid feedback on the state of the individual components. In this case, the controller 11 is connected, for example, to a transmitter 5 for transmitting the at least one control signal and to a receiver 6 for receiving at least one feedback signal from at least one modulator M₁, M₂, . . . , Mₙ. At least one modulator M₁, M₂, . . . , Mₙ is connected to a receiver 6 for receiving at least one control signal and to at least one transmitter 5 for transmitting at least one feedback signal. Transmitting/receiving units which each comprise a transmitter 5 and a receiver 6 and can be used both to transmit and to receive electromagnetic radiation may also be involved.

One of the abovementioned signal transmission systems can be advantageously used in a converter because a converter comprises a plurality of power semiconductor switches S₁, S₂, . . . , Sₙ which can be switched in a reliable manner using the inventive signal transmission system and thus have a high level of availability. The inventive converters are additionally mechanically stable and are insensitive to contamination to the greatest possible extent.

### LIST OF REFERENCE SYMBOLS

1 Drive device

11 Controller

2 Power-electronics circuit

3 First transmission path

4 Second transmission path

5 Transmitter

6 Receiver

7 Reference value

8 Third transmission path

M₁, M₂, . . . , Mₙ Modulator

G₁, G₂, . . . , Gₙ Control electrode driver stage

S₁, S₂, . . . , Sₙ Power semiconductor switch

F₁, F₂, . . . , Fₙ Monitoring sensor

1. A signal transmission system for driving at least one power semiconductor switch of a power-electronics circuit from a controller, each power semiconductor switch being connected to a respective control electrode driver stage
the controller being able to transmit at least one control signal to at least one modulator using at least one first transmission path and the at least one modulator being able to transmit at least one drive signal to each of the control electrode driver stages using a respective second transmission path, wherein
at least one control signal and/or at least one drive signal can be transmitted from a transmitter, which has an antenna for transmitting electromagnetic radiation, to a receiver, which has an antenna for receiving electromagnetic radiation, using electromagnetic radiation,
the at least one associated transmission path being wireless.

2. The signal transmission system as claimed in claim 1, wherein
the at least one control signal and/or at least one drive signal, which can be transmitted using electromagnetic radiation and whose at least one associated transmission path is wireless, is/are modulated using a modulation method and has/have at least one carrier frequency in the range from 0.4 GHz to 400 GHz.

3. The signal transmission system as claimed in claim 1, wherein
the at least one control signal can be transmitted using electromagnetic radiation and the at least one associated first transmission path is wireless, wherein the controller comprises a transmitter having an antenna for transmitting electromagnetic radiation, wherein
at least one modulator comprises a receiver having an antenna for receiving electromagnetic radiation and the controller is connected to the transmitter, and wherein
the at least one modulator is connected to a respective receiver.

4. The signal transmission system as claimed in claim 1, wherein
the at least one drive signal can be transmitted using electromagnetic radiation, wherein
the at least one associated second transmission path is wireless, wherein at least one modulator is connected to a respective transmitter having an antenna for transmitting electromagnetic radiation, wherein at least one control electrode driver stage is connected to a respective receiver having an antenna for receiving electromagnetic radiation, and a respective second transmission path leads from each transmitter to a respective receiver.

5. The signal transmission system as claimed in claim 1, wherein
at least one of the power semiconductor switches is connected to a respective monitoring sensor for measuring a respective state value, wherein
the at least one state value can be converted into a respective feedback signal, wherein
at least one third transmission path leads from at least one of the monitoring sensors to at least one modulator or to the controller for the purpose of transmitting a respective feedback signal, wherein
the at least one feedback signal can be transmitted using electromagnetic radiation, and
the at least one associated third transmission path is wireless.

6. The signal transmission system as claimed in claim 5, wherein
the at least one monitoring sensor comprises a respective transmitter having an antenna for transmitting electromagnetic radiation, wherein
the at least one modulator or the controller comprises a respective receiver having an antenna for receiving electromagnetic radiation, wherein
at least one monitoring sensor is connected to a respective transmitter, and
the at least one modulator or the controller is connected to the at least one receiver.

7. A signal transmission system for driving at least one power semiconductor switch of a power-electronics circuit from a controller, each power semiconductor switch being connected to a respective control electrode driver stage
the controller being able to transmit at least one control signal to at least one modulator using at least one first transmission path,
the at least one modulator being able to transmit at least one drive signal to each of the control electrode driver stages using a respective second transmission path,
at least one of the power semiconductor switches being connected to a respective monitoring sensor for measuring a respective state value,
the at least one state value being able to be converted into a respective feedback signal,
at least one third transmission path leading from at least one of the monitoring sensors to at least one modulator or to the controller for the purpose of transmitting a respective feedback signal, and
at least one feedback signal being able to be transmitted using electromagnetic radiation,
wherein
the at least one monitoring sensor comprises a respective transmitter having an antenna for transmitting electromagnetic radiation, wherein
at least one modulator or the controller comprises a respective receiver having an antenna for receiving electromagnetic radiation, wherein
at least one monitoring sensor is connected to a respective transmitter, wherein
at least one modulator or the controller is connected to the at least one receiver, and wherein
the associated at least one third transmission path is wireless.

8. The signal transmission system as claimed in claim 1, wherein
the at least one feedback signal, which can be transmitted using electromagnetic radiation and whose at least one associated transmission path is wireless, is modulated using a modulation method and
has at least one carrier frequency in the range from 0.4 GHz to 400 GHz.

9. A converter comprising a plurality of power semiconductor switches and having a signal transmission system as claimed in claim 1.
